(19) United States
(12) Patent Application Publication
(10) Pub. No.: US 2004/0015976 A1
(43) Pub. Date: Jan. 22, 2004

(54) Optimized distributed resource management system with digital signature

(75) Inventor: Wah Lam, Fremont, CA (US)

Correspondence Address: David B. Ritchie, Thelen Reid & Priest LLP, P.O. Box 64064, San Jose, CA, 95164, US

(73) Assignee: Sun Microsystems, Inc., a Delaware Corporation

(21) Appl. No.: 10/186,988

(22) Filed: Jun. 28, 2002

(51) Int. Cl. G06F 9/00

(52) U.S. Cl. 718/104

(57) ABSTRACT

A method allocates computing resources from a resource pool. Each job request includes attributes and a unique identifier. A digital signature is generated for each job request based on the combination of the attributes. The identifier is associated with the digital signature. Job requests having identical attributes are grouped together.

### FIELD OF THE INVENTION

The present invention relates to distributed computing. More particularly, the present invention relates to managing resources in a distributed computing environment.

### BACKGROUND OF THE INVENTION

In a distributed computing environment, work can be performed on multiple computing entities, often referred to as “nodes.” One example of a node is a computer system on which one or more processes or threads may execute. Nodes in a distributed computing environment are typically communicatively coupled, for example via a network, to allow processes on any given node to access resources on other nodes. In a hardware context, a resource is generally a device such as a printer, disk drive or memory. In a software context, a resource is generally a set or item of data or a routine.

An important concern in a distributed computing environment is how to manage access to resources by remote processes to ensure that work is completed in an orderly and efficient manner. In a typical scenario, a resource pool sets forth the available resources of all the computing entities. User job requests are gathered and listed with their respective attributes in a database. An allocation engine matches the attributes of the job request to a resource selected from the resource pool. The allocation engine involves assigning job requests to resources from the resource pool in a manner that avoids, or at least reduces conflicts between resources for a particular job request.

The allocation engine can also be part of a distributed resource management system (DRMS) that manages the resource pool, and is responsible for matching resource requests with available resources in the pool. Typically in large scale DRMS, the number of concurrent requests that DRMS has to match with resources is large, for example, in the thousands, or tens of thousands.

The DRMS needs to allocate huge storage areas for the large number of resource requests and thus has to spend a considerable amount of time going through all the requests. Since the DRMS has to match each and every resource request to an available resource, the overall time to match request to resource could be very long, particularly when a large number of requests is present in a large scale domain with hundreds of thousands of resources.

A need therefore exists for a distributed resource management system that avoids the limitations of the approaches previously described. In particular, a need exists for a DRMS operating more efficiently, particularly in the presence of a large scale domain.

### BRIEF DESCRIPTION OF THE INVENTION

A method allocates computing resources from a resource pool. Each job request includes attributes and a unique identifier. A digital signature is generated for each job request based on the combination of the attributes. The identifier is associated with the digital signature. Job requests having identical attributes are grouped together.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram of a distributed resource management system in accordance with a specific embodiment of the present invention;

FIG. 2 is a block diagram of a structure of a job request in accordance with a specific embodiment of the present invention;

FIG. 3 is block diagram illustrating a structure of a database in a distributed resource management system in accordance with a specific embodiment of the present invention;

FIG. 4 is a flow diagram illustrating a method for allocating resources in accordance with a specific embodiment of the present invention;

### DETAILED DESCRIPTION

Embodiments of the present invention are described herein in the context of a optimized distributed resource management system with digital signature. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

A distributed resource management system (DRMS) manages resource pool and matches resource requests with available resources in the pool. The DRMS identifies and groups job requests having identical attributes. Each job request has a unique identifier. Each group is associated with a digital signature. Because the group of job requests with identical attributes can be operated on as a single unit, fewer checks against resources are performed than having all requests checked individually against all resources in the pool. An available resource from a resource pool is then assigned to each group. The available resource has characteristics matching the attributes of the job requests.

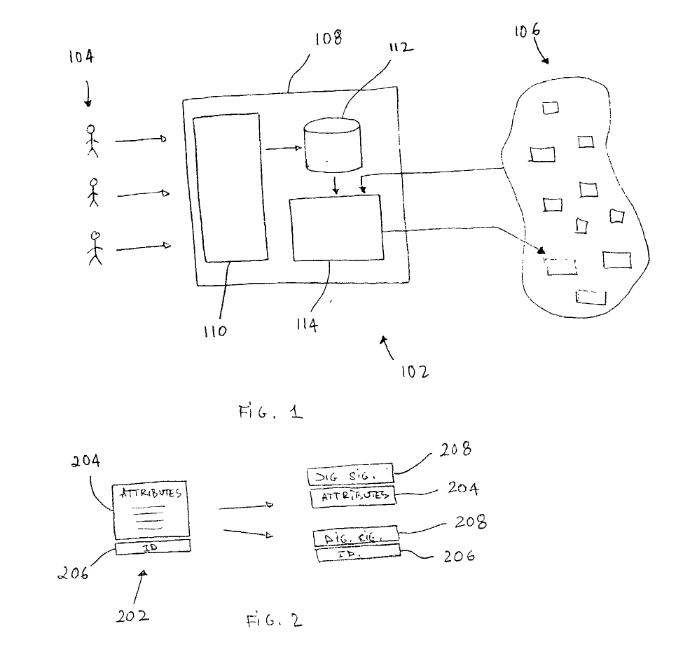

FIG. 1 is a block diagram of a distributed resource management system in accordance with a specific embodiment of the present invention. In a distributed computing system 102, users 104 each submit a job request to a resource pool 106. The job requests are matched with available resources from the resource pool 106 through a distributed resource management system (DRMS) 108. One of ordinary skill in the art will recognize that the present invention is also applicable to grid resource management system (GRMS).

In accordance with one specific embodiment of the present invention, the DRMS 108 comprises a front end component 110, a memory, for example in the form of a database 112, and an allocation engine 114. One of ordinary skill in the art will recognize that the memory or storage may take many other forms. The front-end component 110 receives the job requests from users 104. All job requests having identical attributes are identified and grouped together. The grouping of job requests having identical attributes enables the DRMS to drastically reduce the number of job requests it has to handle. After grouping job requests with identical attributes, the front-end component 110 stores the list of grouped job requests in the database 112. The allocation engine 114 retrieves the stored job requests from the database 112. Because of the grouping of job requests stored in the database 112, the DRMS needs less time to retrieve job requests from the database 112. One of ordinary skill in the art will recognize that other means of data persistence besides a database can be used. The resource pool 106 provides the allocation engine with the status of all the available resources in resource pool 106. For example, one particular resource may have a processing frequency of 1 GHz and 128 MB of available memory. The allocation engine 114 then matches a job request having attributes with an available resource having matching attributes.

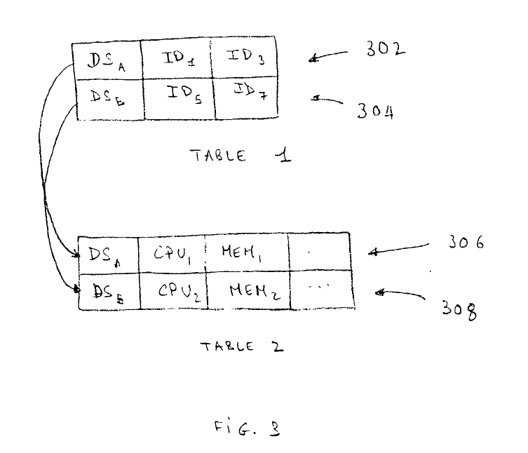

FIG. 2 is a block diagram of a structure of a job request in accordance with a specific embodiment of the present invention. Every job request 202 includes attributes 204 and a unique identifier 206. The attributes may include, for example, the following: processor frequency, memory size, operating system version, swap disk, license, and disk space. One of ordinary skill in the art will recognize that attributes are not limited to the above.

A digital signature 208 is generated using the identical attributes of a job request group. One of ordinary skill in the art will recognize there are many methods for generating a digital signature. For example, a library with a base 64 encoder may be used to generate a digital signature using the attributes of a job request. The digital signature 208 is then associated with the identical attributes 204. The unique identifier 206 for each job request belonging to a group of job requests having identical attributes is associated with the generated digital signature 208.

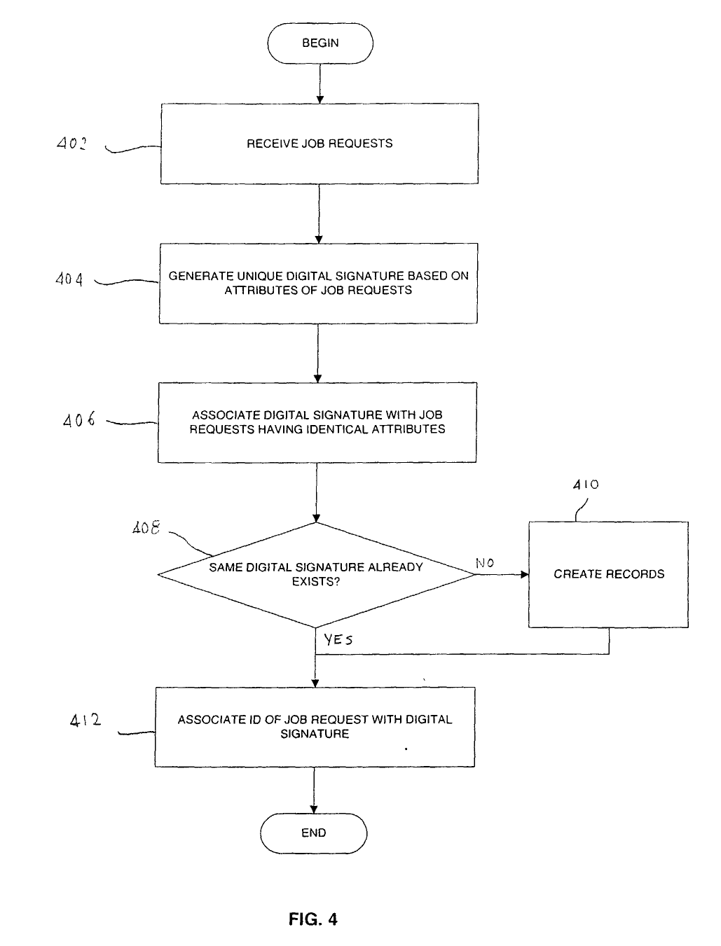

FIG. 3 is block diagram illustrating a structure of a database in a distributed resource management system in accordance with a specific embodiment of the present invention. The digital signatures generated for job requests having identical attributes are associated with the unique identifier from each job request with identical attributes listed in table 1. For example, two job requests that have the same attributes, and different identifiers ID1, ID3 respectively are associated with the same digital signature DSA in row 302. Two other job requests that have the same attributes, and different identifiers ID5, and ID7 respectively are associated with the same digital signature DSB in row 304. Table 1 is stored in the database 112. Because of the grouping of job requests having identical attributes, the size of table 1 has been reduced. The attributes of job requests with identical attributes are stored in table 2. Since job requests with identical attributes are identified with their generated digital signatures, for example, DSA and DSB, each digital signature is associated with the identical attributes. For example, in row 306 of table 2, DSA is associated with CPU1, MEM1, and other attributes. Similarly, in row 308 of table 2, DSB is associated with CPU2, MEM2, and other attributes.

When another job request having a unique identifier, for example, ID8, with the identical attributes from CPU1, MEM1, and the like, is submitted. The front-end component generates digital signature DSA and associates the new job request IDS with DSA in row 302 of table 1. Table 1 is linked to table 2, for example, using a pointer. For example, job request with IDS is linked to the attributes associated with the same digital signature in row 306 in table 2.

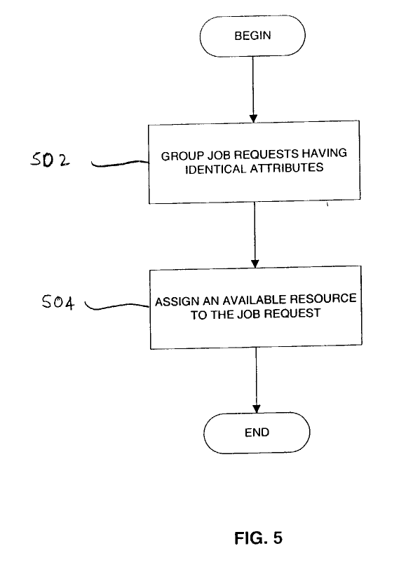

FIG. 4 is a flow diagram illustrating a method for allocating resources in accordance with a specific embodiment of the present invention. A DRMS receives job requests from users at 402. Each job request has a unique identifier and has several attributes as specified above. At 404, DRMS generates a unique digital signature to the combination of the attributes. One of ordinary skill in the art will recognize there are many methods for generating a digital signature. For example, a library with a base 64 encoder may be used to generate a digital signature using the attributes of the job request. At 406, job requests having identical attributes thus have the same digital signature. That digital signature is thus associated with all the identifiers of all job requests having identical attributes.

At 408, if the same digital signature already exists in the database of the DRMS, another job requests then has the same attributes. Otherwise, the DRMS creates a record for the job request, identifier, and the digital signature in a database at 410. If records of the digital signature already exists in the database, the DRMS only needs to associate the identifier of the new job request with the already existing digital signature in the database at 412. The DRMS may then have faster access to the database since its size has been reduced. The DRMS may then assign available resources from a resource pool to the job requests based on the attributes. For example, job requests having identical attributes are queued for processing on a particular resource that meets the demands of the job requests.

FIG. 5 is a flow diagram illustrating a method for allocating resources in accordance with another specific embodiment of the present invention. At 502, job requests having identical attributes are recognized and grouped together. At 504, an available resource meeting the requirements of the attributes of the job requests is assigned to a job request from the group of job requests with identical attributes.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for allocating computing resources comprising:
receiving a job request, said job request including a plurality of attributes and an identifier;
generating a digital signature for said job request based on said plurality of attributes; and
associating said identifier with said digital signature.

2. The method of claim 1 wherein each digital signature is unique to a combination of said plurality of attributes.

3. The method of claim 2 further comprising:
storing said identifier in a first memory unit; and
storing said plurality of attributes associated with said digital signature in a second memory unit, said first memory unit linked to said second memory unit.

4. The method of claim 3 further comprising:
assigning an available resource from a resource pool to said job request, said available resource having a plurality of characteristics matching said plurality of attributes of said job request.

5. A method for allocating computing resources comprising:
grouping job requests having identical attributes, each job request having a unique identifier, each group of said job requests with identical attributes associated with a unique digital signature; and
assigning an available resource from a resource pool to each group of said job requests with identical attributes, said available resource having characteristics matching said identical attributes of said group of job requests.

6. An apparatus for allocating computing resources comprising:
means for receiving a job request, said job request including a plurality of attributes and an identifier;
means for generating a digital signature for said job request based on said plurality of attributes; and
means for associating said identifier with said digital signature.

7. The apparatus of claim 6 wherein each digital signature is unique to a combination of said plurality of attributes.

8. The apparatus of claim 7 further comprising:
means for storing said identifier in a first memory unit; and
means for storing said plurality of attributes associated with said digital signature in a second memory unit, said first memory linked to said second memory unit.

9. The apparatus of claim 8 further comprising:
means for assigning an available resource from a resource pool to said job request, said available resource having a plurality of characteristics matching said plurality of attributes of said job request.

10. An apparatus for allocating computing resources comprising:
means for grouping job requests having identical attributes, each job request having a unique identifier, each group of said job requests with identical attributes associated with a unique digital signature; and
means for assigning an available resource from a resource pool to each group of said job requests with identical attributes, said available resource having characteristics matching said identical attributes of said group of job requests.

11. A program storage device readable by a machine, tangibly embodying a program of instructions readable by the machine to perform a method for allocating computing resources, the method comprising:
receiving a job request, said job request including a plurality of attributes and an identifier;
generating a digital signature for said job request based on said plurality of attributes; and
associating said identifier with said digital signature.

12. The method of claim 11 wherein each digital signature is unique to a combination of said plurality of attributes.

13. The method of claim 12 further comprising:
storing said identifier in a first memory unit; and
storing said plurality of attributes associated with said digital signature in a second memory unit, said first memory unit linked to said second memory.

14. The method of claim 13 further comprising:
assigning an available resource from a resource pool to said job request, said available resource having a plurality of characteristics matching said plurality of attributes of said job request.

15. A program storage device readable by a machine, tangibly embodying a program of instructions readable by the machine to perform a method for allocating computing resources, the method comprising:
grouping job requests having identical attributes, each job request having a unique identifier, each group of said job requests with identical attributes associated with a unique digital signature; and
assigning an available resource from a resource pool to each group of said job requests with identical attributes, said available resource having characteristics matching said identical attributes of said group of job requests.

16. An apparatus for allocating computing resources comprising:
a receiver receiving a job request, said job request including a plurality of attributes and an identifier;
a generator coupled to said receiver, said generator generating a digital signature for said job request based on said plurality of attributes; and
a coupler coupled to said generator, said coupler associating said identifier with said digital signature.

17. The apparatus of claim 16 wherein each digital signature is unique to a combination of said plurality of attributes.

18. The apparatus of claim 17 further comprising:
a first memory unit coupled to said coupler, said first memory unit storing said identifier in a first memory; and
a second memory unit coupled to said coupler, said second memory unit storing said plurality of attributes associated with said digital signature in a second memory unit, said first memory unit linked to said second memory unit.

19. The method of claim 18 further comprising:
an assigner coupled to said first memory unit and second memory unit, said assigner assigning an available resource from a resource pool to said job request, said available resource having a plurality of characteristics matching said plurality of attributes of said job request.

20. An apparatus for allocating computing resources comprising:
a grouper, said grouper grouping job requests having identical attributes, each job request having a unique identifier, each group of said job requests with identical attributes associated with a unique digital signature; and
an assigner coupled to said grouper, said assigner assigning an available resource from a resource pool to each group of said job requests with identical attributes, said available resource having characteristics matching said identical attributes of said group of job requests.
